(19) United States
(12) Patent Application Publication
(10) Pub. No.: US 2004/0145283 A1
(43) Pub. Date: Jul. 29, 2004

(54) Assembly method and device for snap together modular elements

(76) Inventor: Darren Saravis, Long Beach, CA (US)

Correspondence Address: GREENBERG TRAURIG LLP, 2450 COLORADO AVENUE, SUITE 400E, SANTA MONICA, CA, 90404, US

(21) Appl. No.: 10/687,900

(22) Filed: Oct. 17, 2003

Related U.S. Application Data
(63) Continuation-in-part of application No. 10/425,542, filed on Apr. 28, 2003.
Application No. 10/425,542 is a continuation of application No. 09/759,898, filed on Jan. 13, 2001, now Pat. No. 6,557,955.

(51) Int. Cl. F16B 12/00

(52) U.S. Cl. 312/111

(57) ABSTRACT

A snap together assembly method and system with alignment markers to facilitate snapping latches and catches together. Panels or other elements connected or attached to latches and/or catches can be connected using this snap together system.

### RELATED APPLICATIONS

This application is a Continuation In Part of U.S. patent application Ser. No. 10/425,542, filed Apr. 28, 2003 entitled “Snap Together Modular Storage”, which is a Continuation of U.S. patent application Ser. No. 09/759,898 filed Jan. 13, 2001 entitled “Snap Together Modular Storage” now U.S. Pat. No. 6,557,955, from which PCT application PCT/US02/00946; filed Jan. 11, 2002 entitled “Assemble-In-Place Modular Storage” derives, all which are hereby incorporated by this reference.

### BACKGROUND OF THE INVENTION

1. Field of the Invention

This present invention relates to a novel assembly device and system. More specifically, to a snap-together device and method whereby panels or other elements with interlocking latches and catches are connected.

2. Related Art

Modular storage systems are useful to allow a user to customize a component system to fit his or her particular needs. Panel type storage whereby a similar side panels are connected via edge members are found in U.S. Pat. No. 5,638,973 issued to Dewey et. al, and U.S. Pat. No. 5,466,058 issued to Chan. In both Dewey and Chan the containers may be stacked by placing a tab-like projection on the bottom edge of one part into a grove-like indentation in the top of another.

U.S. Pat. No. 5,888,114 issued to Slocum et al., teaches a toy assembly or modular storage system which has a self-supporting edge element to it. The Slocum storage system is a series of similar panels, which form cubes via a slide together extruded mating edge with a catch running down the periphery of one edge and a latch running down the other side. Once two panels are latched in the slide-together fashion, the panel edges can only be disassembled by sliding them apart. Slocum illustrates a plethora of configurations for the slide-in catch and corresponding slide-in latch, all relying on an extruded latch and catch which teaches no alignment guides or stops to maintain the plumb alignment of connected panels. Slocum's slide together mating system connects 4 panels to form a four wall box.

A remaining challenge in the field of snap together connectable elements or panels is to provide a connection whereby panels or elements can easily snap together. An additional challenge is to form snap together 5 or 6 sided structures. The present invention overcomes such challenges and prior limitations by creating a snap-in latch and catch connection or attachment for use with panels or other elements.

### INVENTION SUMMARY

The present invention is a snap together assembly device and system. Structural elements, design elements and/or panels can be snapped together. In one embodiment each panel has a front and a back side and four edges and four corners. On at least one side of each comer, viewed from a front or a back side is found a latch/catch pair. At each adjacent corner is formed another latch/catch pair, the sequence of latch to catch is alternating around one or both sides and mirror on the opposite side. The sequence may also be non-alternating with two or more latches or two or more catches adjacent to one another proceeding around one or both sides.

The catch is elongated and semi-rigid, having adequate electricity, memory and/or lubricity to deform and snap-back into place upon insertion or removal of the corresponding elongated latch.

Panels, structural elements, and/or design element, snap together forming a substantially right angle. Additional panels, structural elements, design elements and/or other connectable elements may be added to form structures. An alignment stop may be added to limit sliding between a latch and a catch which may cause misalignment. At or near the corners between each adjacent pair of edges on each panel a buttress can be formed. Two adjacent buttresses support each other and act as a larger comer support which further stabilizes the structures. Placement of one or more alignment marks formed at or near a latch and/or catch, which may also be formed on a latch or catch, can simplify connection of a latch and/or a catch.

Although the embodiments indicate the latches and/or catches are formed as part of each panel, affixing the latches and catches near corner locations to a panel is also contemplated and set forth within. Advantages to affixing the latches and/or catches include combining dissimilar materials which are impossible or difficult to co-mold. A non-exclusive list of such materials include, but is not limited to, a metal frame, a wood frame, a rattan frame, a rattan grid, a wicker grid, a wicker frame, metal sheet, cardboard, fiberboard, foam, laminate, wood or a metal grid panel. Doors and wheels may also be added to a cube, panel or structure. The panels may have protruding or recessed surface features which may form a support skeleton for a grid like panel and may be used to provide pathways or guides for shelves and/or drawers. A grid or frame may also support canvas, vinyl, quilted fabric, mesh fabric, lined fabric, foam, unlined fabric or other soft material.

The features of the invention believed to be novel are set forth with particularity in the appended claim. The invention itself, however, both as to configuration, and method of operation, and the advantages thereof, may be best understood by reference to the following descriptions taken in conjunction with the accompanying drawings.

### BRIEF DESCRIPTION OF THE DRAWINGS

FIG. 1A is a front perspective view of the preferred embodiment of the modular storage system.

FIG. 1B is a front view of an unattached comer of one panel of the preferred embodiment.

FIG. 1C is a rear view of an unattached comer of one panel of the preferred embodiment.

FIG. 1D is a perspective view of an attached front comer of the preferred embodiment.

FIG. 1E is a cut-away side view along line A-A of FIG. 1D.

FIG. 2A is a front perspective view of a first alternate embodiment of the modular storage system.

FIG. 2B is a front view of an unattached comer of one panel of the embodiment of FIG. 2A.

FIG. 2C is a rear view of an unattached comer of one panel of the embodiment of FIG. 2A.

FIG. 2D is a blow-up of a front corner connection of the embodiment of FIG. 2A. FIG. 2E is a cut-away side view along line A-A of FIG. 2C.

FIG. 2F is a cut-away edge view of the intersection of four cubes.

FIG. 3A is a front perspective view of a second alternate embodiment of the modular storage system.

FIG. 3B is a blown-up back perspective view of a, slide-on, comer latch/catch of the embodiment of FIG. 3A.

FIG. 3C is a blown-up front perspective view of a, slide-on, comer latch/catch of the embodiment of FIG. 3A.

FIG. 3D is a blow-up rear perspective view of a, slide-on, corner latch/catch of the embodiment of FIG. 3A.

FIG. 3E is a blow-up of a front comer connection of the embodiment of FIG. 3A. FIG. 3F is a cut-away side view along line A-A of FIG. 3E.

FIG. 4 is a perspective view of one arrangement of the connected panels.

FIG. 5A is a perspective view of a second arrangement of the connected panels.

FIG. 5B is a component view showing the door and attachment to FIG. 5A.

FIG. 5C is a component view showing the wheel and attachment to FIG. 5A.

FIG. 6 is a perspective view of a third arrangement of the connected panels.

FIG. 7 is a front view of a first alternate panel embodiment.

FIG. 8 is a front view of a second alternate panel embodiment.

FIG. 9A is an assembly view of a latch/catch pair with alignment marks.

FIG. 9B is front perspective view of the latch/catch pair of the embodiment shown in FIG. 9A.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### PREFERRED EMBODIMENT OF THE INVENTION

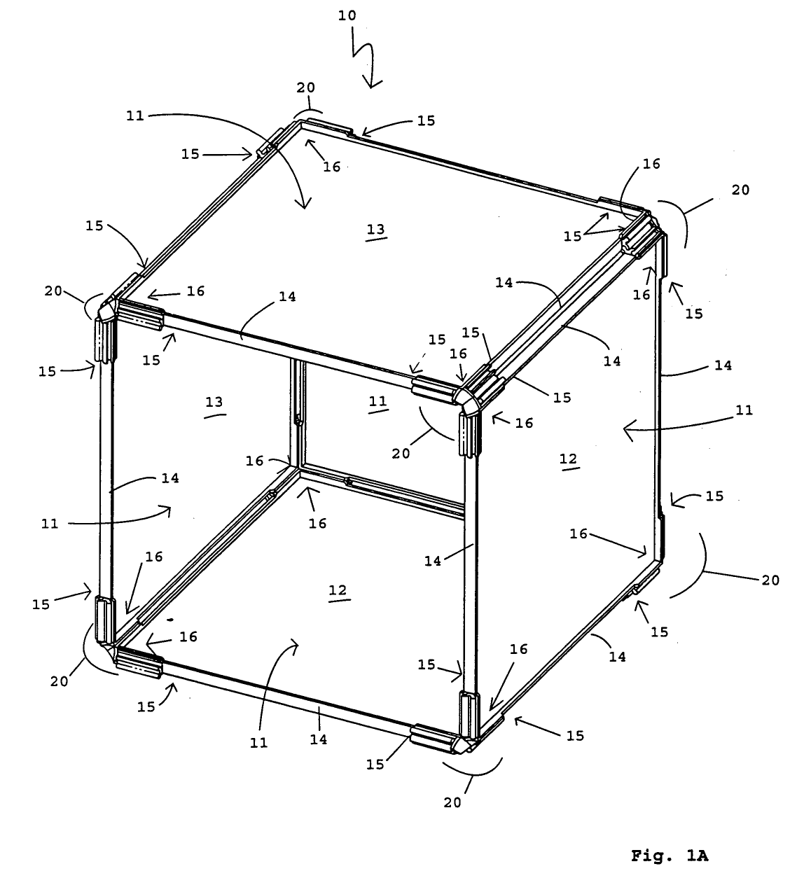

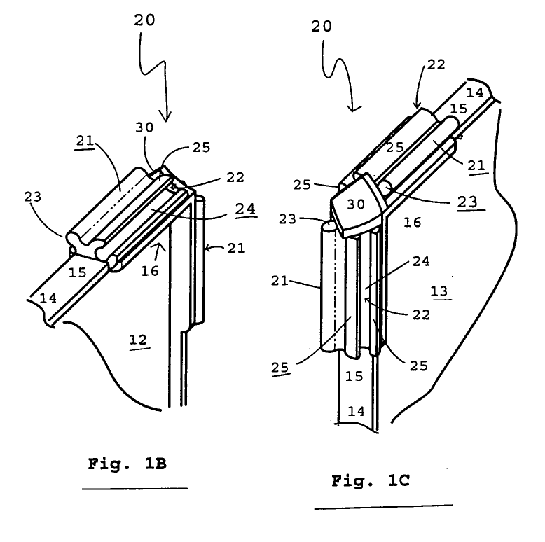

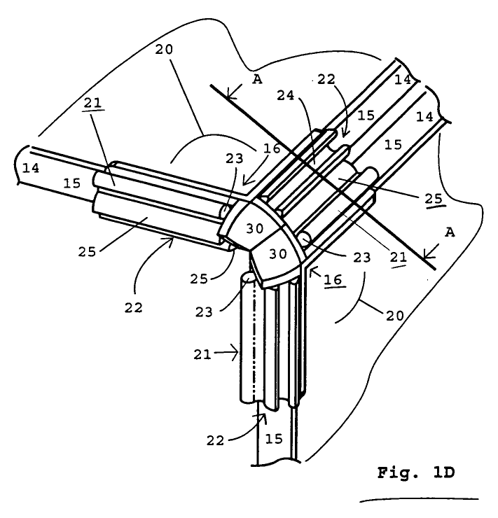

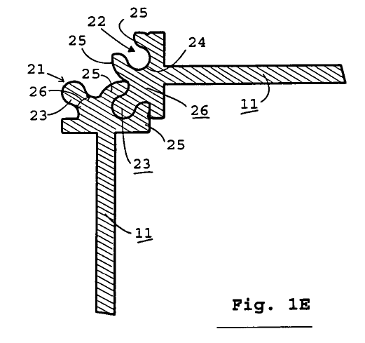

Shown in FIG. 1A is a front perspective view of the preferred embodiment, generally designated 10.

The cube is formed of five four sided panels 11. Each panel has a front 12 and a back side 13 face and an edge 14 at each side. At each end 15, of each edge 14, near the comers 16 of each panel 11, a latch/catch pair 20 is formed. Viewed from the edge 14, a latch 21 and a catch 22 are formed near the comer 16. The latch/catch pairs 20 are reversed such that on any given edge 15 of a panel 11 one latch 21 will be exposed on one side and one catch 22 will be exposed on the other side. This configuration allows alternating panels to be used to construct the entire structure.

Shown in FIG. 1A is a front perspective view of the preferred embodiment, generally designated 10.

The cube is formed of five four sided panels 11. Each panel has a front 12 and a back side 13 face and an edge 14 at each side. At each end 15, of each edge 14, near the corners 16 of each panel 11, a latch/catch pair 20 is formed. Viewed from the edge 14, a latch 21 and a catch 22 are formed near the corner 16. The latch/catch pairs 20 are reversed such that on any given edge 15 of a panel 11 one latch 21 will be exposed on one side and one catch 22 will be exposed on the other side. This configuration allows alternating panels to be used to construct the entire structure.

Shown in FIGS. 1B, 1C, 1D and 1E, are front and rear perspective view of a corner of an unattached panel, a perspective view of an attached front comer and a cut away view of FIG. 1D at line A-A.

In FIGS. 1B & 1C the latches 21 shape is shown, the tab projection forming the latch is elongated with an enlarged head 23 at its distal end which reversibly snaps into the corresponding elongated catch 22 slot 24 and extends at approximately a 45 degree angle from the panel The panels may be a frame or grid, preferably these panels and latch/catch pair 20 are preferably an injection molded part constructed out of acrylonitrile-butadiene-styrene “ABS”, Acetal, Acylic or Nylon. However, depending on the intended use, materials such as polycarbonate, polypropylene or polyurethane may be substituted. An alignment stop 30 is formed at the junction of each edge 14. The alignment stop 30 prohibits the type of movement common to latch/catch panels which are connected via an extruded latch or catch which mount together via a slide-in function. Additionally, as shown in FIG. 1D the alignment stops 30 form a buttress between panels enhancing the structural integrity of the structure.

In FIG. 1E the enlarged head 23 forming the latch is shown mated firmly within the slot 24 of the catch 22, by constructing the catch 22 out of a material with sufficient lubricity, flexibility and/or memory, the enlarged head 23 may be withdrawn or snapped-out of the slot 24 by displacing the slot walls 25 which can snap-back, undamaged, upon withdrawal. A sufficiently flexible slot wall 25 also places less stress on the neck 26 of the latch 21 thereby minimizing the risk of neck damage during attachment or detachment of panels.

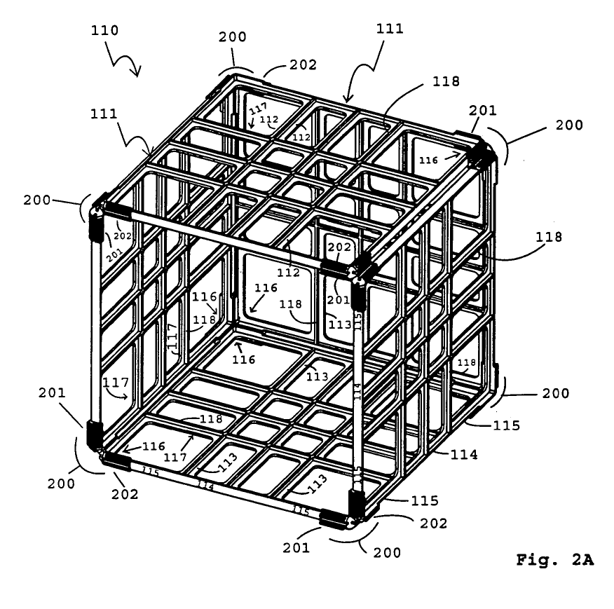

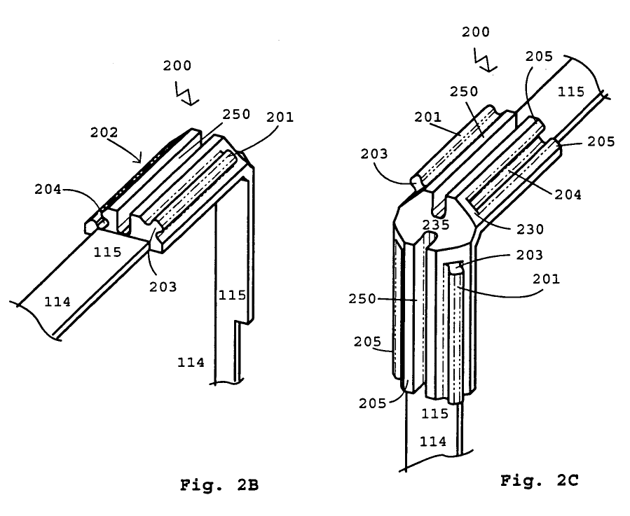

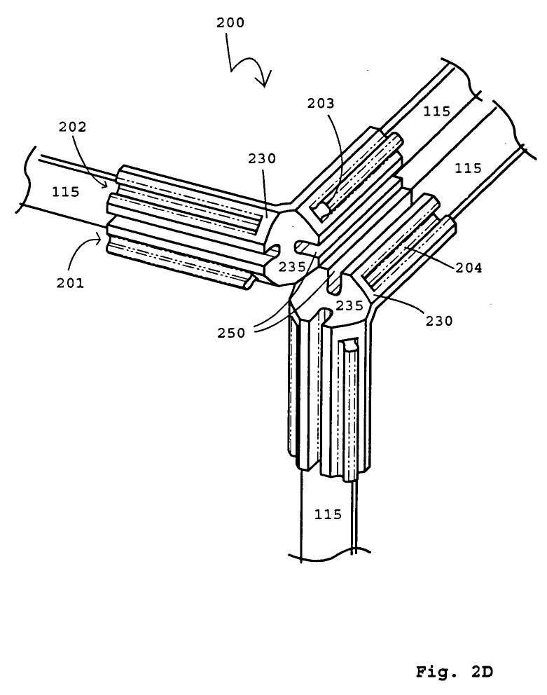

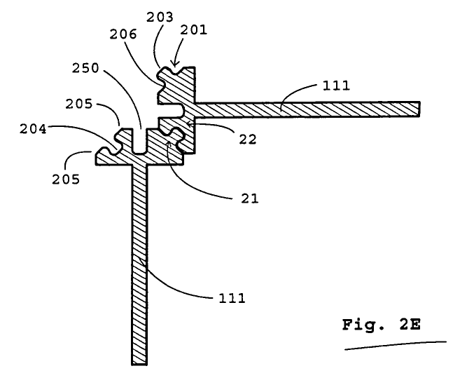

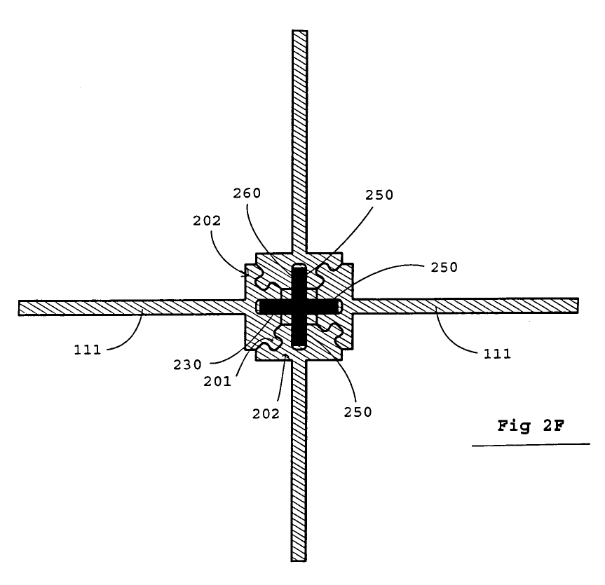

Referring now to FIG. 2A there is illustrated a front perspective view of a first alternate embodiment of the modular storage system, generally designated 110.

The cube is formed of five square panels 111. Each panel 111 is a square frame with an open grid structure formed therein. Each panel has a front 112 and a back side 113 face and an edge 114 at each side. At each end 115, of each edge 114, near the corners 116 of each panel 111, a latch/catch pair 200 is formed. A panel grid 117 is formed within the boundary of the edges 114 and a raised grid support 118 may be extended from the panel grid to provide greater stability to the panel grid 117 and panel 111. Viewed from the edge 114, a latch 201 and a catch 202 are formed near the corner. The latch/catch pairs 200 are reversed such that on any given edge 114 of a panel 111 one latch 201 will be exposed on one side and one catch 202 will be exposed on the other side. This configuration allows similar alternating panels, with corresponding latch/catch pairs 200 to be used to construct the entire structure.

Variations in the side panels are anticipated and discussed within. Side panels may be constructed in a wide variety of forms, with different surface features, cut-outs, skeletal structures, protrusions and the like without departing form the intended scope of the invention.

Shown in FIGS. 2B, 2C, 2D and 2E, are a front and rear perspective view of a comer of an unattached panel, a perspective view of an attached front comer, a cut away view of FIG. 2D at line A-A, and a cut-away edge view of the intersection of four cubes.

In FIGS. 2B & 2C the latch 201 shape is illustrated, the tab projection forming the latch has a enlarged head 203 which snaps in a reversible fashion into the corresponding catch 202 slot 204. The panels are preferably an injection molded part constructed out of polypropylene, ABS, polycarbonate or nylon which provides flexibility and durability. An alignment stop 230 is formed at the junction of each edge 114. The alignment stop 230, adjacent to an angular corner buttress 235, prohibits forward and back movement of a latch 201 within a catch 202. Additionally, the combination of two or more adjacent comer buttresses 235 (FIG. 2D) forms a larger comer support further enhancing the structural integrity of the structure.

In FIG. 2D the enlarged head 203 forming the latch is shown mated firmly within the slot 204 forming the catch 202, by constructing the panels out of a material with sufficient flexibility, memory and/or lubricity the enlarged head 203 may be withdrawn or snapped-out of the slot 204 without damaging the slot walls 205 or the neck 206 of the latch 201. A support guide 250 is formed between the latch 201 and the catch 202. In FIG. 2F a support rod 260 of a size and shape to mate with the support guide 250 is shown. The support rod can be used to preclude removal of a panel when such action needs to be restricted, as may be the case with young children or in commercial, school or business locations.

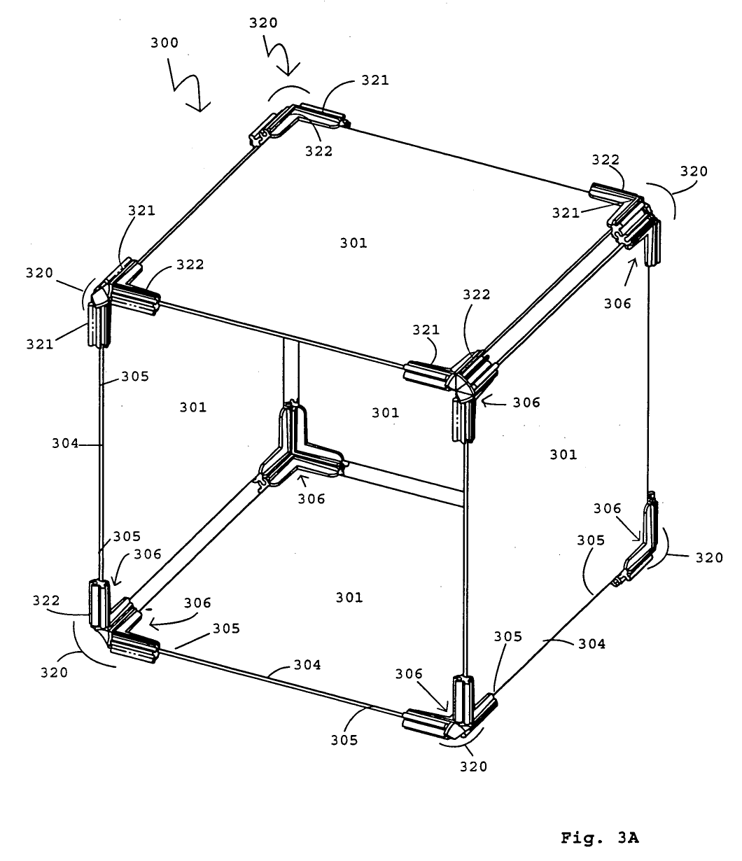

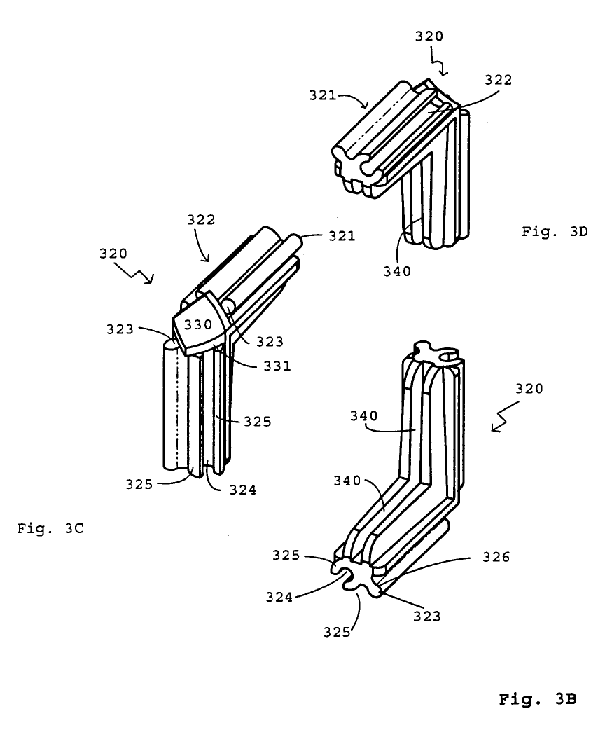

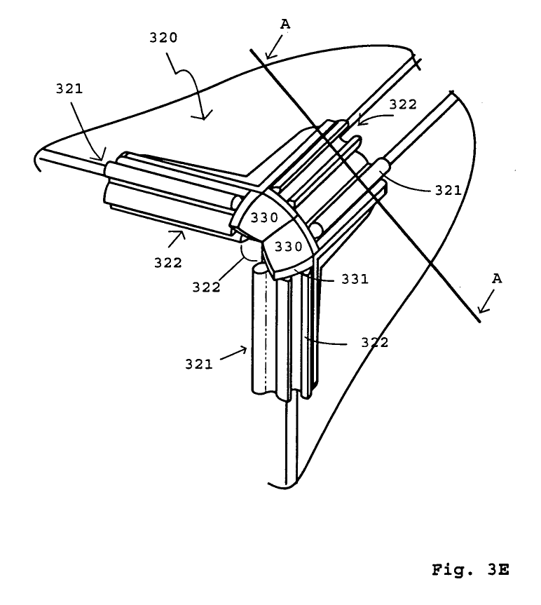

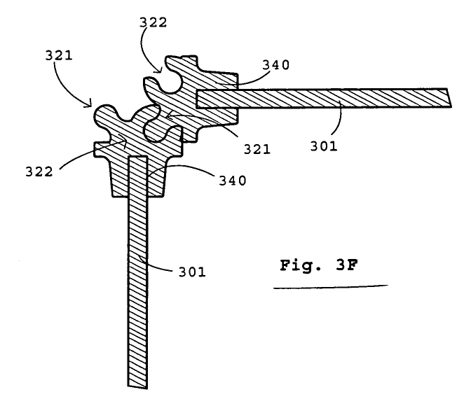

FIG. 3A shows a front perspective view of a second alternate embodiment of the modular storage system, generally designated 300.

The cube is formed of five panels 301. Each panel 301 is of a similar size. Each panel side has an edge 304. At each end 305, of each 304, near the comers 306 of each panel 301, a latch/catch pair 320 is affixed. Viewed from the edge 304, latch 321 and a catch 322 are attached near the corner 306. The latch/catch pairs 320 are reversed such that on any given edge 304 of a panel 301 one latch 321 will be exposed on one side and one catch 322 will be exposed on the other side. This configuration allows alternating panels to be used to construct the entire structure.

In FIGS. 3B, 3C, 3D, 3E and 3F, there is shown a front, back and rear perspective view of the slide-on comer catch/latch, a perspective view of an attached front corner, a cut away view of FIG. 3E at line A-A, and a cut-away edge view of the intersection of four cubes.

In FIGS. 3B, 3C, and 3D the latch 321 shape is illustrated, the tab projection forming the latch is elongated and has a enlarged head 323 which snaps in a reversible fashion into the corresponding catch 322 slot 324. The latch/catch pairs 320 are preferably an injection molded part constructed out of polypropylene, ABS, polycarbonate, high durometer rubber, or nylon which provides flexibility and durability. An alignment stop 330 is formed at the comer junction of each latch/catch pairs 320. FIG. 3E illustrates the position of the alignment stops 330 which inhibits movement of a latch 321 within a catch 322 thereby enhancing the structural integrity of the structure. Surrounding each corner buttress 330 is a support edge 331 which engages an adjacent support edge 331 [MK to resolve double 331] of a panel affixed adjacent and forms the larger corner support 332. A panel mating guide 340 is formed opposite each latch/catch pair 320. It is via this panel mating guide 340 that each panel 301 is fitted into the latch/catch pair 320. It is envisioned that each panel 301 will be solidly affixed to the panel mating guide 340. The nature of the attachment will be dependent on the material the panel is constructed of, adhesives, locking tabs, sonic welds, glue, rivets, crimping and the like may be used.

Variations in the side panels are anticipated and discussed within. A non-exclusive list of possible side panel materials are a metal frame, a wood frame, a rattan frame, a rattan grid, a wicker grid, a wicker frame, metal sheet, cardboard, fiberboard, laminate, wood or a metal grid panel frame, canvas, mesh, fabric, framed wire mesh, coated wire, plastic grids, wood, metal, plastic, composites, sheet steel (stainless, hot or cold rolled carbon steel, or any alloy), brass, or copper stamped or formed, woven metal or plastic and metal frames inserted molded into plastic.

In FIG. 3F the enlarged head 323 forming the latch is shown mated firmly within the slot 324 forming the catch 322. By constructing the latch/catch pairs 320 out of a material with sufficient lubricity the enlarged head 323 may be withdrawn or snapped-out of the slot 324 without damaging the slot walls 325 or the neck 326 of the latch 321.

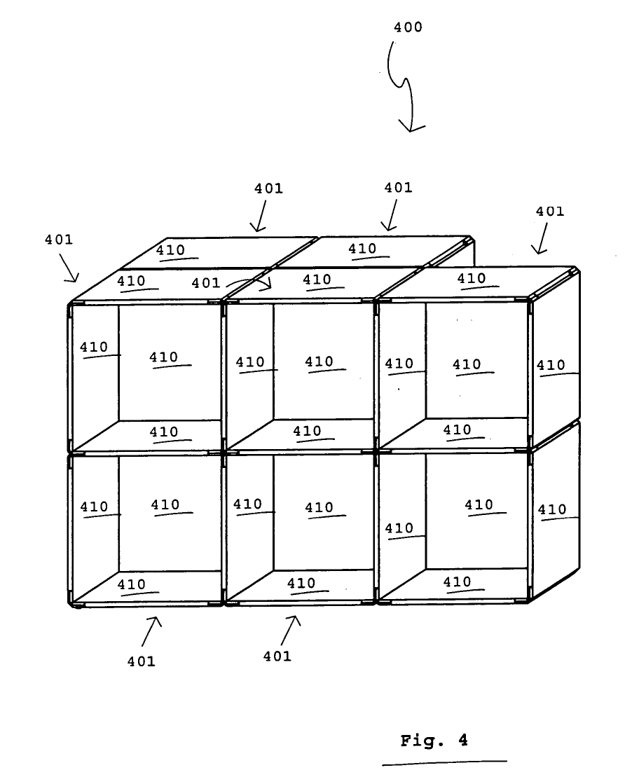

Shown in FIG. 4 there is illustrated a perspective view of one arrangement of the connected panels, generally designated 400.

A series of cubes 401 are attached together with one panel 410 acting as a common panel shared between cubes 401. A latch-catch pair (as described in FIGS. 1-3) is found on opposite sides of each panel 410 to facilitate snap together construction of the cubes 401.

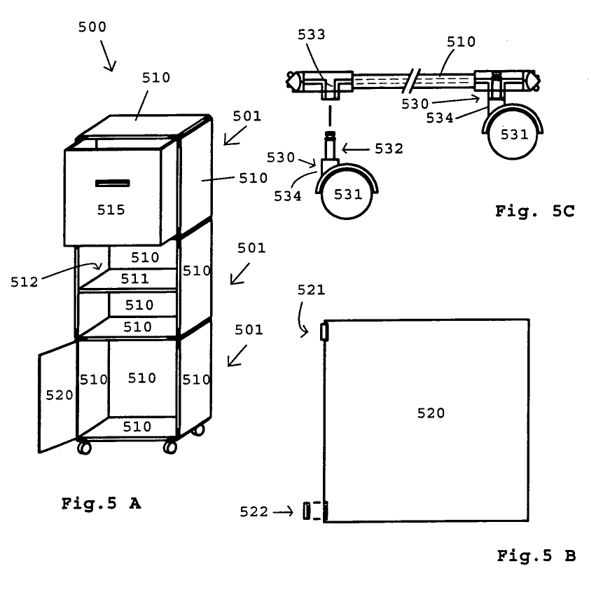

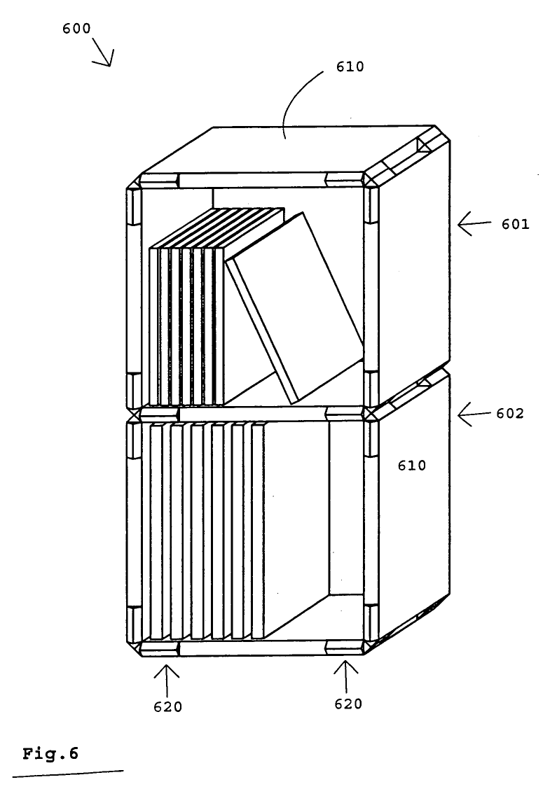

Shown in FIGS. 5A, 5B and 5C there is a perspective view of a second arrangement of the connected panels, generally designated 500 forming a vertical storage case with wheels (FIG. 5C) and a swing door (FIG. 5B).

A series of cubes 501 are attached together (as described in FIGS. 1-4) constructed out of identical panels 510 forming a tower. A shelf member 511 is held within a guide 512 formed as part of the surface feature of the panels 510.

A hinged door 520 attaches to one of the cubes 501 via a hinge which has on latch 521 and one catch 522 (as described in FIGS. 1-3). A group of removable caster-type wheel modules 530 are affixed one per bottom comer, to the tower 500. Each wheel module 530 has one wheel 531 and rod 532, which mates with a bose 533 formed in each comer of the bottom panel 510. Each rod 532 extends from a wheel stop 534 and mates with the bose 533.

Shown in FIG. 6 there is a perspective view of a third arrangement of the connected panels, generally designated 600.

A series of cubes 601 are attached together (as described in FIGS. 1-4) constructed out of panels 610 forming a tower. In the configuration the cubes 601 are of a scale for desktop use to hold pads, paper, pens, clips, computer disks, CDs or other media storage devices. A series of rubber pads 620 may be affixed to the bottom surface of the lower cube 601 to inhibit slippage on a desktop.

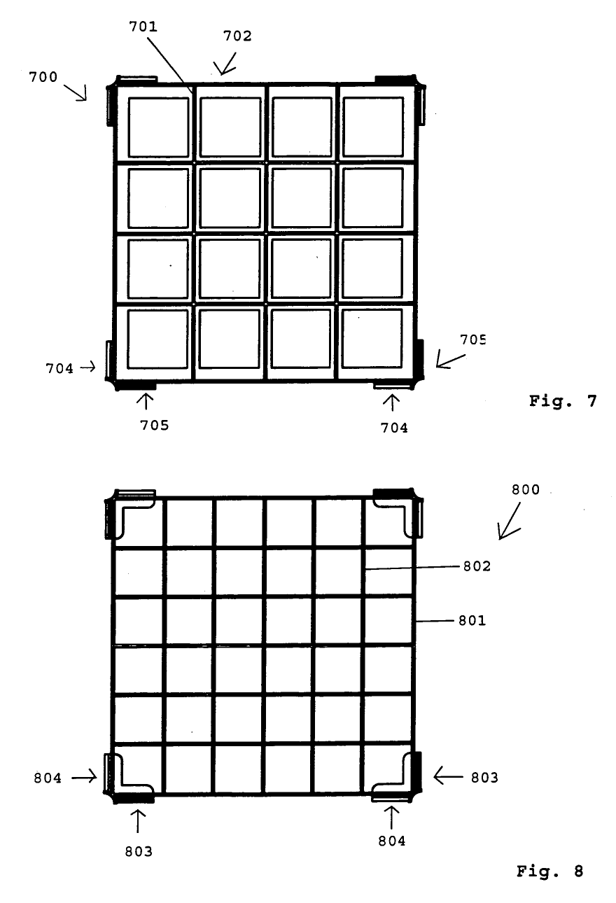

Shown in FIGS. 7 & 8 there are front views of a first and second alternate panel embodiments generally designated 700 & 800 respectively.

In FIG. 7 there is a metal and plastic panel which has a wire insert 701 embedded within a preferably clear or translucent plastic structure 702, within a four sided square frame 703. On opposite ends of each side of the square frame 703 a latch 704 and a catch 705 (as previously described in FIGS. 1-3) are affixed, or formed as a part thereof. On the back face (not shown) of the panel 700 opposite each latch 704 is a catch 705 and opposite each catch 705 is a latch 704.

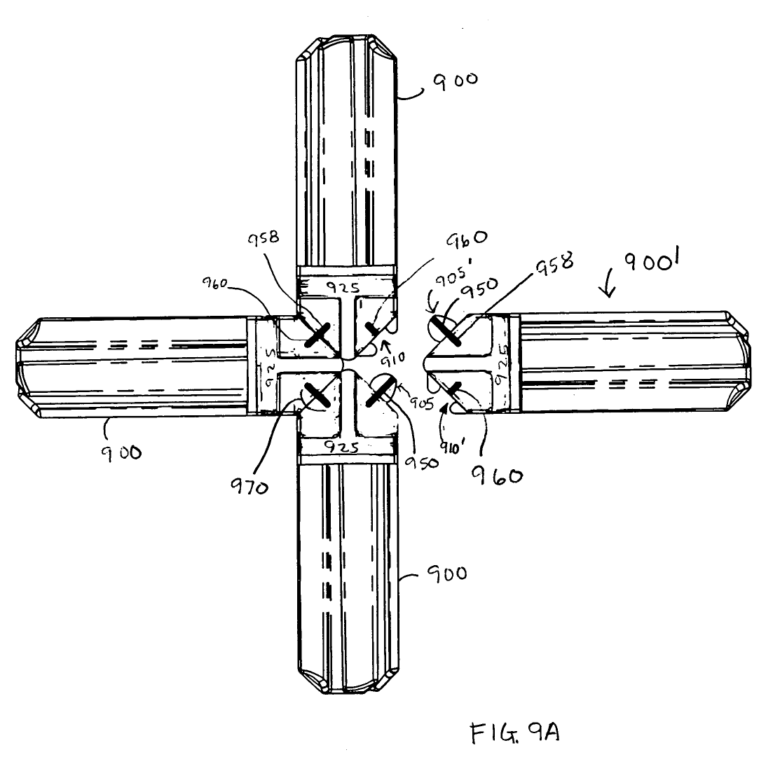

In FIG. 8 a square four sided frame 801 supports a central mesh 802 affixed at opposite ends of each side of the square frame 801 is a latch 803 and a catch 804 (as previously described in FIGS. 1-3). On the back face (not shown) of the panel 800 opposite each latch 803 is a catch 804 and opposite each catch 804 is a latch 803. The square frame 801 and/or the mesh 802 may be constructed of plastic, metal or metal coated with a rubber-like material, lacquered, painted or metal plated.

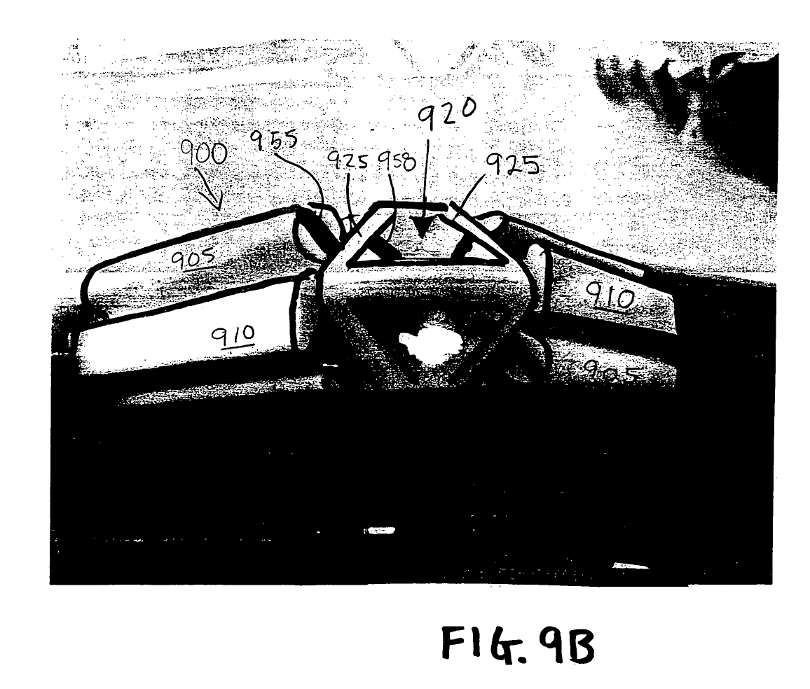

In FIGS. 9A and 9B are shown another embodiment of latch/catch pairs 900 and 900′. Shown in FIG. 9A are three attached latch/catch pairs 900 and one unattached latch/catch pair 900′. Viewed from ends latch 905′ catch 910′ are positioned opposite an unattached latch 905 and an unattached catch 910. A buttress 920 with alignment stops 925 (FIG. 9B) is shown on each of the latch/catch pairs 900 & 900′.

Connection of a latch 905′ to a catch is simplified with a latch alignment marker 950 which can be aligned to a catch alignment marker 960 formed adjacent to the catch 910 on an alignment stop 925.

In this embodiment, when a latch 905 and catch 910 are properly affixed an inner portion 955 the latch alignment marker 950 is hidden from view behind the alignment stop 925. However, the visible portion 958 of the latch alignment marker 950 and the catch alignment marker 960 forms a substantially straight marker line 970 indicating proper assembly.

Those skilled in the art will recognize that a latch alignment marker, or a catch alignment marker may be a design, mark, color, pattern, indicator, glyph, texture or any other identifiable marker and can be used in concert with, or independent of, other such identifiable markers to facilitate assembly.

Since certain changes may be made in the above apparatus without departing from the scope of the invention herein involved, it is intended that all matter contained in the above description, as shown in the accompanying drawing, shall be interpreted in an illustrative, and not a limiting sense.

I claim:

1. An attachable panel comprising:
a panel with at least two corners;
a latch and a catch, each catch with deformable slot walls and each latch with a head extending, located near each corner;
at least one alignment stop, whereby sliding movement between a connected latch and catch is limited;
a latch alignment marker formed on the latch; and,
a catch alignment marker formed on the catch.

2. A snap together panel connection system comprising:
at least two panels each with at least one edge and two corners;
a latch and a catch, each catch with deformable slot walls and each latch with a head extending, located adjacent to the edge near each corner; whereby panels are attached when the enlarged head of one panel snaps into a catch of another panel by displacing the slot walls; and,
a means for aligning at least one latch or catch with a corresponding latch or catch.

3. The system of claim 2 wherein the means for aligning is a latch alignment marker formed on at least one latch.

4. The system of claim 2 wherein the means for aligning is a catch alignment marker formed on at least one catch.

5. The system of claim 2 wherein the means for aligning is:
a catch alignment marker formed on at least one catch; and
a latch alignment marker formed on at least one latch.

6. The system of claim 2 further comprising at least one alignment stop, whereby sliding movement between a connected latch and catch is limited.

7. A method of assembly, the method comprising:
aligning the latch alignment marker of a latch on one panel with the catch alignment marker of a catch on another panel; and,
snapping the aligned latch into the corresponding catch and thereby attaching panels.
